(19) United States
(12) Patent Application Publication
(10) Pub. No.: US 2005/0139782 A1
(43) Pub. Date: Jun. 30, 2005

(54) Face image detecting method, face image detecting system and face image detecting program

(76) Inventors: Toshinori Nagahashi, Nagano-ken (JP); Takashi Hyuga, Suwa-shi (JP)

Correspondence Address: HARNESS, DICKEY & PIERCE, P.L.C., P.O. BOX 828, BLOOMFIELD HILLS, MI, 48303, US

(21) Appl. No.: 11/022,069

(22) Filed: Dec. 23, 2004

(30) Foreign Application Priority Data
Dec. 26, 2003 (JP) 2003-434177

(51) Int. Cl. G01J 1/58

(52) U.S. Cl. 250/459.1

(57) ABSTRACT

A face image detecting method, detecting system and detecting program are provided. After dividing the detection target area into a plurality of blocks and dimensionally compressing the area, feature vectors including a representative value in each block are calculated and then a discriminator detects whether the face image exists or not in the detection target area by using the feature vectors. The discriminator detects after an image feature quantity is dimensionally compressed to the extent of not damaging the feature of face image. Since the number of image feature items to be used for discrimination is substantially reduced from the number of pixels within the detection target area to that of blocks, the number of operations drastically decreases and a face image can be quickly detected.

### RELATED APPLICATIONS

This application claims priority to Japanese Patent Application No. 2003-434177 filed Dec. 26, 2003 which is hereby expressly incorporated by reference herein in its entirety.

### BACKGROUND

1. Technical Field

The present invention concerns pattern recognition and object recognition technologies, and more specifically, the invention relates to a face image detecting method, detecting system and detecting program for quickly detecting whether a face image exists or not from an image in which it is unclear whether the face image exists or not.

2. Background Art

With recent advancements of pattern recognition technology and information processors such as computers, the recognition accuracy of text and sound has been dramatically improved. However, in the pattern recognition of a human image, an object, landscape and so on, e.g., an image scanned from a digital camera and so on, it is known that it is still difficult to accurately and quickly identify whether a human face is visible in the image or not.

However, automatically and accurately identifying whether a human face is visible in the image or not and who the human is by a computer and so on has been an extremely important theme to establish a living body recognition technology, improve security, accelerate criminal investigations, speed up image data reduction and retrieval and so on. With regard to such a theme, many proposals have been made.

In JP-A-9-50528 and the like, the existence of flesh color area is first determined in an input image, and the mosaic size is automatically determined in the flesh color area to convert a candidate area into mosaic pattern. Then the existence of a human face is determined by calculating the proximity from a human face dictionary and mis-extraction due to the influence of background and so on can be reduced by segmenting the human face. Thereby the human face can be automatically and effectively detected from the image.

In the conventional technology, however, although a human face is detected from an image based on “flesh color”, there is a problem that the “flesh color” has different color areas in some cases due to an influence of lighting and so on so that the face image cannot be detected or cannot be narrowed down depending on the background and other problems.

The present invention has been achieved to effectively solve the aforementioned problems. An object of the invention is to provide a novel face image detecting method, detecting system and detecting program capable of quickly and accurately detecting an area with a high possibility for a human face image to exist from an image in which it is unclear whether the face image exists or not.

### SUMMARY

To solve the aforementioned problems, a face image detecting method for detecting whether a face image exists or not in a detection target image according to Aspect 1 comprises: after selecting a specific area within the detection target image as a detection target area, calculating edge strength within the selected detection target area and dividing the detection target area into a plurality of blocks based on the calculated edge strength, calculating feature vectors including a representative value in each block and then determining whether the face image exists or not in the detection target area by inputting these feature vectors into a discriminator.

In other words, as the technology of extracting a face image from an image in which it is unclear whether the face image is included or not and where the face image is included, there is a method of detecting based on a feature vector specific to the face image calculated from luminance and so on, as well as a method using a flesh color area as described above.

In a method using a normal feature vector, however, even in the case of detecting a face image of only 24-pixels by 24-pixels, an operation has to be performed using as many as 576 (24 by 24)-dimensional feature vectors (576 vector elements). Therefore, the face image cannot be quickly detected.

Consequently, in the invention as described above, after dividing the detection target area into a plurality of blocks, feature vectors including a representative value in each block are calculated and then a discriminator detects whether the face image exists or not in the detection target area by using the feature vectors. In other words, the discriminator detects after an image feature quantity is dimensionally compressed to the extent of not damaging the feature of face image.

Thereby, since the number of image feature items to be used for discrimination is substantially reduced from the number of pixels within the detection target area to that of blocks, the number of operations decreases drastically and a face image can be quickly detected. Further, the use of edge strength makes it possible to detect the face image almost free from lighting variations.

In a face image detecting method according to Aspect 1, a face image detecting method according to Aspect 2 is characterized in that a size of the block is determined based on an auto-correlation coefficient.

In other words, as will be described later, since it becomes possible to dimensionally compress by using an auto-correlation coefficient and blocking to the extent of not damaging the original feature of face image based on the coefficient, the face image can be more quickly and accurately detected.

In a face image detecting method according to Aspect 1 or 2, a face image detecting method according to Aspect 3 is characterized in that a luminance within the detection target area is calculated instead of or together with the edge strength and the feature vectors including a representative value in each block are calculated based on the luminance.

Thereby a face image can be accurately and quickly detected when the face image exists within the detection target area.

In a face image detecting method according to one of Aspects 1 to 3, a face image detecting method according to Aspect 4 is characterized in that a variance or an average of an image feature quantity of pixels configuring each block is used as a representative value in each block.

Thereby the feature vectors to be input into the discriminating part can be accurately calculated.

In a face image detecting method according to one of Aspects 1 to 4, a face image detecting method according to Aspect 5 is characterized in that a support vector machine having learned a plurality of sample face images and sample non-face images is used as the discriminator.

In the invention, in other words, a support vector machine is used as a discriminating part for the generated feature vectors. Thereby whether a human face image exists or not in the selected detection target area can be quickly and accurately detected.

The “support vector machine (Support Vector Machine: hereafter properly referred to as “SVM”)” used in the invention, as will be described later, was proposed with the framework of statistical learning theory by V. Vapnik working for AT & T in 1995, and is a learning machine capable of obtaining a hyperplane suitable for separating all two-class input data linearly by using an index called margin, which is known as one of the most excellent learning models in pattern recognition ability. Also, as will be described later, high discrimination ability can be exerted by using a technique called kernel trick even in the case where it is impossible to separate linearly.

In a face image detecting method according to Aspect 5, a face image detecting method according to Aspect 6 is characterized in that a nonlinear kernel function is used as an identification function of the support vector machine.

A method of making it possible to classify nonlinearly by this support vector machine, on the other hand, includes achieving high dimension, which is a method of achieving linear separation in a feature space by mapping original input data to a higher-dimensional feature space by nonlinear mapping. Thereby as a result, a nonlinear discrimination is performed in the original input space.

However, since numerous calculations are necessary to obtain this nonlinear mapping, a calculation of an identification function called “kernel function” can be used instead of the calculation of nonlinear mapping. This technique is called kernel trick, by which a direct calculation of nonlinear mapping can be prevented and calculating difficulty can be overcome.

Therefore as the indication function of the support vector machine used in the invention, the use of this nonlinear “kernel function” makes it possible to easily separate even a high-dimensional image feature vector which includes data normally incapable of being linearly separated.

In a face image detecting method according to one of Aspects 1 to 4, a face image detecting method according to Aspect 7 is characterized in that a neural network having previously learned a plurality of sample face images and sample non-face images is used as the discriminator.

This neural network is a model of a computer emulating a neural network of brain. Especially a PDP (Parallel Distributed Processing) model which is a multi-layer type neural network can perform a pattern learning incapable of being linearly separated and is a representative classification method for a pattern recognition technology. However, it is said that the use of high-dimensional feature quantity generally decreases discrimination ability in the neural network. In the invention, since the dimension of the image feature quantity is compressed, such a problem does not occur.

Therefore, the use of such a neural network instead of the SVM as the discriminator also makes it possible to quickly and accurately discriminate.

In a face image detecting method according to one of Aspects 1 to 7, a face image detecting method according to Aspect 8 is characterized in that the edge strength within the detection target area is calculated by using a Sobel operator in each pixel.

This “Sobel operator”, in other words, is a difference type edge detection operator for detecting a spot at which a contrast sharply changes such as an edge or a line in an image.

Therefore, the generation of edge strength or edge variance in each pixel by using the “Sobel operator” makes it possible to generate an image feature vector.

In addition, the shape of the “Sobel operator” is as shown in FIG. 9 (a: horizontal edge, b: horizontal edge), and after calculating a square sum of the results generated in each operator, the edge strength can be obtained by calculating a square root.

A face image detecting system for detecting whether a face image exists or not in a detection target image in which it is unclear whether the face image is included or not according to Aspect 9 comprises: an image scanning part for scanning a specific area within the detection target image as a detection target area; a feature vector calculating part for calculating feature vectors including a representative value in each block by dividing the detection target area scanned in the image scanning part into a plurality of blocks; and a discriminating part for discriminating whether the face image exists or not in the detection target area based on the feature vectors including a representative value in each block obtained in the feature vector calculating part.

Thereby, as in Aspect 1, since the number of image feature items to be used for discrimination in the discriminating part is substantially reduced from the number of pixels within the detection target area to that of blocks, the face image can be quickly and automatically detected.

In a face image detecting system according to Aspect 9, a face image detecting system according to Aspect 10 is characterized in that the feature vector calculating part comprises: a luminance calculating part for calculating a luminance in each pixel within the detection target area scanned in the image scanning part; an edge calculating part for calculating edge strength within the detection target area; and an average/variance calculating part for calculating an average or a variance of a luminance obtained in the luminance calculating part or edge strength obtained in the edge calculating part, or calculating an average or a variance of both.

Thereby, as in Aspect 4, the feature vectors to be input into the discriminating part can be accurately calculated.

In a face image detecting system according to Aspect 9 or 10, a face image detecting system according to Aspect 11 is characterized in that the discriminating part comprises a support vector machine having previously learned a plurality of sample face images and sample non-face images.

Thereby, as in Aspect 5, whether a human face image exists or not in the selected detection target area can be quickly and accurately detected.

A face image detecting program for detecting whether a face image exists or not in a detection target image in which it is unclear whether the face image is included or not according to Aspect 12 makes a computer function as: an image scanning part for scanning a specific area within the detection target image as a detection target area; a feature vector calculating part for calculating feature vectors including a representative value in each block by dividing the detection target area scanned in the image scanning part into a plurality of blocks; and a discriminating part for discriminating whether the face image exists or not in the detection target area based on the feature vectors including a representative value in each block obtained in the feature vector calculating part.

Thereby since the same effect as in Aspect 1 can be obtained and since it becomes possible to realize each function in software by using a general-purpose computer system such as a PC, the function can be realized more economically and easier as compared to the case realized by creating special hardware. In addition, an improvement of the function can be easily attained only by rewriting a program.

In a face image detecting program according to Aspect 12, a face image detecting program according to Aspect 13 is characterized in that the feature vector calculating part comprises: a luminance calculating part for calculating a luminance in each pixel within the detection target area scanned in the image scanning part; an edge calculating part for calculating edge strength within the detection target area; and an average/variance calculating part for calculating an average or a variance of a luminance obtained in the luminance calculating part or edge strength obtained in the edge calculating part or calculating an average or a variance of both.

Thereby, as in Aspect 4, the image feature vectors most suitable to be input into the discriminating part can be accurately calculated, and, as in Aspect 12, since it becomes possible to realize each function in software by using a general-purpose computer system such as a PC, the function can be realized more economically and easily.

In a face image detecting program according to Aspect 12 or 13, a face image detecting program according to Aspect 14 is characterized in that the discriminating part comprises a support vector machine having previously learned a plurality of sample face images and sample non-face images.

Thereby, as in Aspect 5, whether a human face image exists or not in the selected detection target area can be quickly and accurately detected, and, as in Aspect 12, since it becomes possible to realize each function in software by using a general-purpose computer system such as a PC, the function can be realized more economically and easily.

### BRIEF DESCRIPTION OF THE DRAWINGS

FIG. 1 is a block diagram showing one embodiment of a face image detecting system.

FIG. 2 is a block diagram showing hardware configuration realizing the face image detecting system.

FIG. 3 is a flowchart showing one embodiment of a face image detecting method.

FIG. 4 is a view showing a change of edge strength.

FIG. 5 is a view showing an average of edge strength.

FIG. 6 is a view showing a variance of edge strength.

FIG. 7 is a graph showing a relationship between a shift of image in a horizontal direction and a correlation coefficient.

FIG. 8 is a graph showing a relationship between a shift of image in a vertical direction and a correlation coefficient.

FIGS. 9A and 9B are views showing a shape of a Sobel filter.

### DETAILED DESCRIPTION

A best mode for carrying out the invention will be described with reference to drawings.

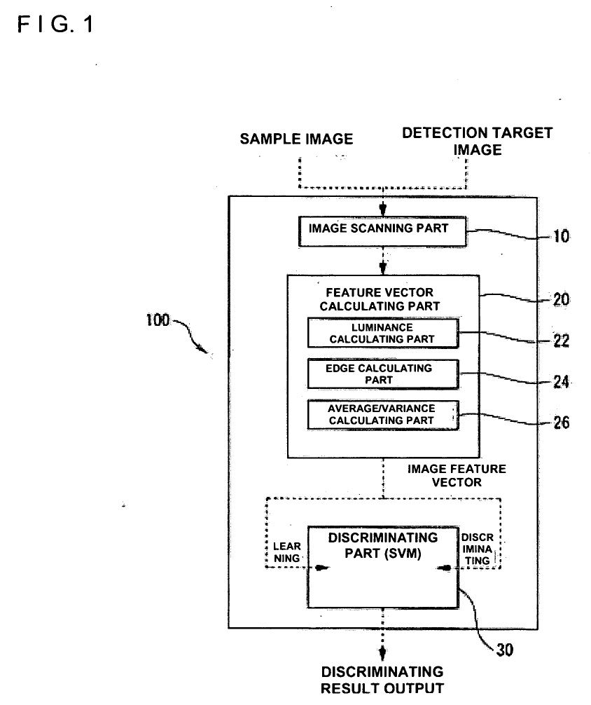

FIG. 1 shows one embodiment of a face image detecting system 100 according to the invention.

As shown in this Figure, the face image detecting system 100 comprises: an image scanning part 10 for scanning a sample face image for learning and a detection target image; a feature vector calculating part 20 for generating a feature vector of the image scanned in the image scanning part 10; a discriminating part 30, an SVM (support vector machine), for discriminating whether the detection target image is a face image candidate area or not from the feature vector generated in the feature vector calculating part 20.

More specifically, the image scanning part 10 includes the CCD (Charge Coupled Device) of digital still camera and of digital video camera, a camera, a vidicon camera, an image scanner, a drum scanner and so on. There is provided a function of A/D converting a specific area within the scanned detection target image and a plurality of face images and non-face images to be sample images for learning and a function of sending the digital data sequentially to the feature vector calculating part 20.

The feature vector calculating part 20 further comprises: a luminance calculating part 22 for calculating a luminance (Y) in the image; an edge calculating part 24 for calculating edge strength in the image; and an average/variance calculating part 26 for calculating edge strength generated in the edge calculating part 24, an average of a luminance generated in the luminance calculating part 22 or a variance of edge strength. An image feature vector in each sample image and detection target image is generated from a pixel value sampled in the average/variance calculating part 26 and the image feature vector is sent sequentially to the SVM 30.

The SVM 30 provides a function of learning the image feature vector of a plurality of face images and non-face images to be samples for learning generated in the feature vector calculating part 20 and a function of discriminating from the learning results whether a specific area within the detection target image generated in the feature vector calculating part 20 is a face image candidate area or not.

The SVM 30, as described above, is a learning machine capable of obtaining a hyperplane most suitable for separating all input data linearly by using an index called margin, and it is known that high discrimination ability can be exerted by using a technique called “kernel trick” even in the case where it is impossible to separate linearly.

The SVM 30 used in this embodiment has: 1. a learning step and 2. a discriminating step.

First in 1, the learning step, as shown in FIG. 1, after scanning many face images and non-face images to be sample images for learning in the image scanning part 10, a feature vector in each image is generated in the feature vector calculating part 20 and learned as an image feature vector.

Next in 2, the discriminating step, by sequentially scanning a specific selection area within the detection target image, generating the image feature vector in the feature vector calculating part 20 and inputting the image feature vector as a feature vector, it is detected whether or not the area has high possibility for the face image to exist according to the area in the hyperplane to be discriminated under which the input image feature vector falls.

Here, with regard to the sizes of sample face image and non-face image for learning, as will be described later, the image with 24-pixels by 24-pixels is blocked into a specific number, for example. Blocking is performed on the area having the same size as the size of the area to be detected after blocking.

Explaining rather in detail about this SVM based on the description in pp. 107-118 of pattern ninshiki to gakusyuu no toukeigaku (Iwanami Shoten, Publishers, co-authored by: Asou Hideki; Tsuda Kouji; and Murata Noboru), when the problem to be discriminated is nonlinear, a nonlinear kernel function can be used in the SVM. The identification function in this case will be expressed by the following Formula 1.

In other words, Formula 1 with “zero” value leads to the hyperplane to be discriminated. The value other than “zero” leads to a distance from the hyperplane to be discriminated calculated from a given image feature vector. The result of formula 1 with nonnegative leads to a face image while with negative leads to a non-face image.

$$f ( ϕ ( x ) ) = {\sum }_{i = 1}^{n} {α}_{i} * {y}_{i} * K ( x , {x}_{i} ) + b \qquad Formula 1$$

In this formula, x denotes a feature vector and xᵢ denotes a support vector. As x and xᵢ, the values generated in the feature vector calculating part 20 are used. K denotes a kernel function and in this embodiment the function of following formula 2 will be used.
K(x, xᵢ)=(a*x*xᵢ+b)^{T} Formula 2

(wherein a=1, b=0, T=2)

In addition, each of the feature vector calculating part 20, the SVM 30, the image scanning part 10 and so on configuring the face image detecting system 100 is actually realized by a computer system such as a PC which is configured by hardware configured by a CPU, RAM and so on and which is configured by a special computer program (software).

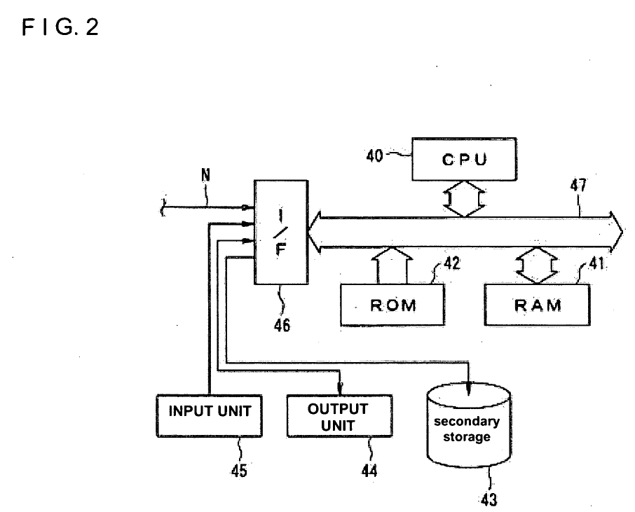

In the hardware for realizing the face image detecting system 100 as shown in FIG. 2, for example, through various internal/external buses 47 such as a processor bus, a memory bus, a system bus and an I/O bus which are configured by a PCI (Peripheral Component Interconnect) bus, ISA (Industrial Standard Architecture) bus and so on, there are bus-connected to each other: CPU (Central Processing Unit) 40 for performing various controls and arithmetic processing; RAM (Random Access Memory) 41 used for a main storage; ROM (Read Only Memory) 42 which is a read-only storage device; a secondary storage 43 such as a hard disk drive (HDD) and a semiconductor memory; an output unit 44 configured by a monitor (LCD (liquid crystal display) and a CRT (cathode-ray tube)) and so on; an input unit 45 configured by an image picking sensor and so on such as an image scanner, a keyboard, a mouse, CCD (Charge Coupled Device) and CMOS (Complementary Metal Oxide Semiconductor); an I/O interface (I/F) 46; and so on.

Then, for example, various control programs and data that are supplied through a storage medium such as CD-ROM, DVD-ROM and a flexible disk (FD) and through a communication network (LAN, WAN, Internet and so on) N are installed on the secondary storage 43 and so on. At the same time, the programs and data are loaded onto the main storage 41 if necessary. According to the programs loaded onto the main storage 41, the CPU 44 performs a specific control and arithmetic processing by using various resources. The processing result (processing data) is output to the output unit 44 through the bus 47 and displayed. The data is properly stored and saved (updated) in the database created by the secondary storage 43 if necessary.

A description will be given about an example of a face image detecting method using the face image detecting system 100.

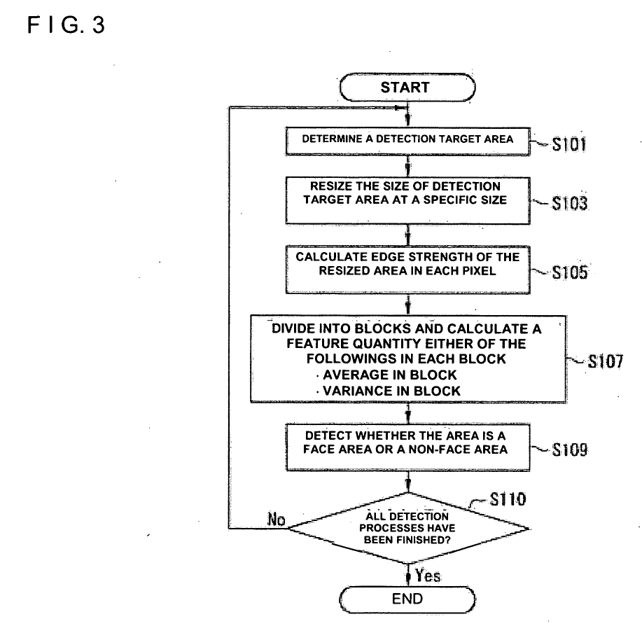

FIG. 3 is a flowchart showing an example of a face image detecting method for an image to be detected actually. Before discriminating by using an actual detection target image, it is necessary to go through a step of learning a face image and a non-face image to be sample images for learning for the SVM 30 to be used for discrimination as described above.

In the learning step, after generating feature vectors in each face image and non-face image to be sample images the feature vectors are input with the information indicating whether the image is a face image or a non-face image. In addition, it is preferable that the image in which the same process is done as in the selected area in the actual detection target image is used for the image for learning used here for learning. In other words, as will be described later, since the image area in the invention to be a discrimination target is dimensionally compressed, discrimination can be performed more quickly and accurately by using the image which has been compressed to the same dimension as in the image area.

When the learning of feature vector of the sample image for the SVM 30 has been finished, first the area to be a detection target within the detection target image will be determined (selected) as shown in step S101 in FIG. 3. In addition, the method for determining the detection target area is not limited in particular, and the area obtained in another face image discrimination method may be adopted as it is, or the area arbitrarily specified within the detection target image by a user of the system and so on. However, since in most cases it is not known whether the face image is included or not as well as where the face image included in principle, it is preferable that whole area is very carefully searched to select an area by beginning from a specific area setting the origin at the upper left corner of the target image area and by shifting by a specific pixel in horizontal and vertical directions, for example. Also, the size of the area is not necessarily uniform, and selection may be made by changing the size properly.

Then when the first area to be the detection target of face image has been selected, moving to step S103 and the size of the first detection target area is resized at a specific size, for example, 24-pixels by 24-pixels. In other words, since the size of the detection target area is unclear as well as it is unclear that whether the face image is included in the image or not, the number of pixels becomes significantly different depending on the size of face image in the area to be selected. Therefore, the size of the selected area is resized at a standard size (24-pixels by 24-pixels) for the moment.

Next, when resizing of the selected area has been finished, moving to step S105 and calculating edge strength of the resized area in each pixel, the area is divided into a plurality of blocks to calculate the average or variance of edge strength within each block.

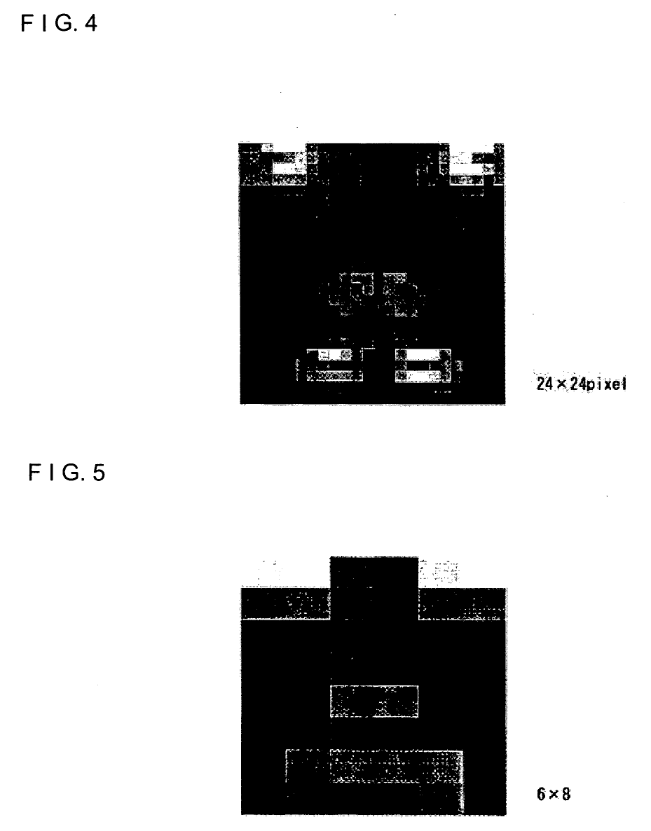

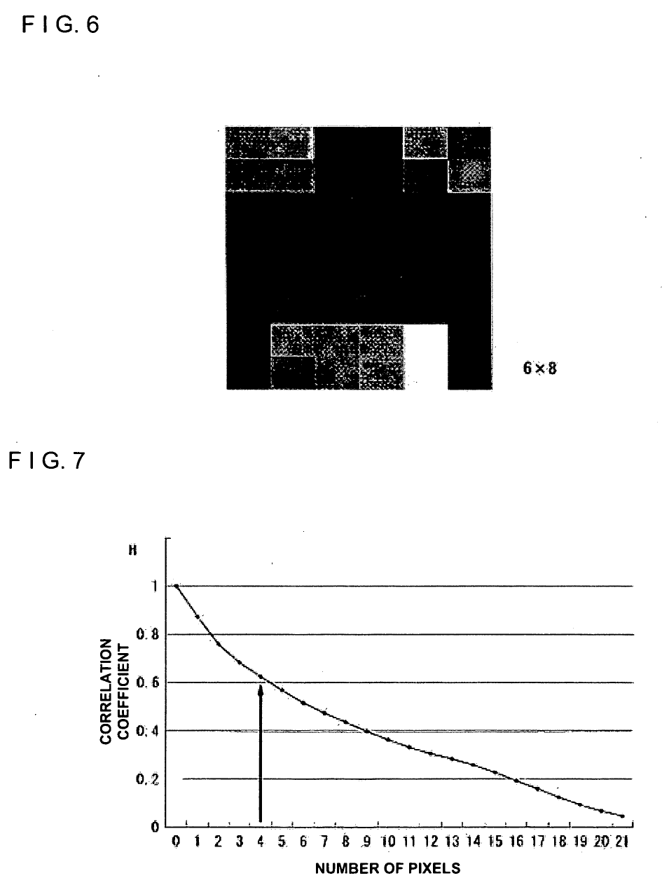

FIG. 4 is an image showing the change of edge strength after resized, in which the calculated edge strength is indicated as 24-pixels by 24-pixels. Also in FIG. 5, the area is further blocked by 6-pixels by 8-pixels and the average of edge strength in each block is indicated as the representative value of each block. Further in FIG. 6, the area is further blocked by 6-pixels by 8-pixels and the variance of edge strength in each block is indicated as the representative value of each block. In these Figures, in addition, the edge parts at both ends of the upper block show “both eyes” of human face, the edge part at the center of the central block shows the “nose” and the edge part at the center of the lower block shows the “lips” of a human face. As in the invention, it is clear the feature of a face image is left as it is even when the dimension is compressed.

With regard to the number of blocks in the area, it is critically important to block based on an auto-correlation coefficient to the extent of not damaging the image feature quantity. When the number of blocks becomes too large, the number of image feature vectors to be calculated increases accordingly and the processing load will increase. Therefore, the acceleration of detection cannot be achieved. In other words, when an auto-correlation coefficient is a threshold value or more, it is conceivable that the value of the image feature quantity or the changing pattern within the block falls within a specific range.

The auto-correlation coefficient can be calculated by the following Formulae 3 and 4. Formula 3 yields the auto-correlation coefficient in a horizontal (width) direction (H) of the detection target image while by Formula 4 yields the auto-correlation coefficient in a vertical (height) direction (V) of the detection target image.

$$h ( j , ⅆ x ) = \frac{{\sum }_{i = 0}^{i = width - 1} ⅇ ( ⅈ + ⅆ x , j ) \cdot ⅇ ( ⅈ , j )}{{\sum }_{i = 0}^{i = width - 1} ⅇ ( ⅈ , j ) \cdot ⅇ ( ⅈ , j )} \qquad Formula 3$$

r: correlation coefficient
e: luminance or edge strength
width: number of pixels in a horizontal direction
i: pixel location in a horizontal direction
j: pixel location in a vertical direction
dx: distance between pixels

$$v ( ⅈ , ⅆ y ) = \frac{{\sum }_{j = 0}^{j = height - 1} ⅇ ( ⅈ , j ) \cdot ⅇ ( ⅈ , j + ⅆ y )}{{\sum }_{j = 0}^{j = height - 1} ⅇ ( ⅈ , j ) \cdot ⅇ ( ⅈ , j )} \qquad Formula 4$$
v: correlation coefficient
e: luminance or edge strength
height: number of pixels in a vertical direction
i: pixel location in a horizontal direction
j: pixel location in a vertical direction
dy: distance between pixels

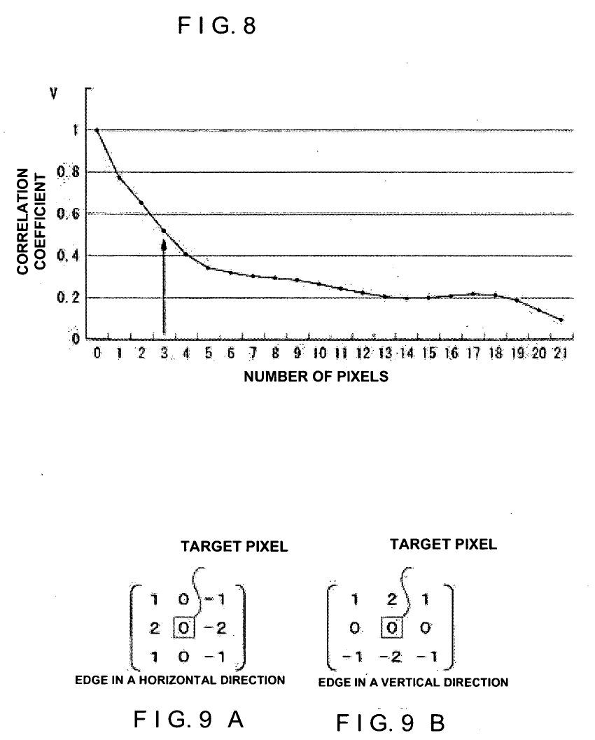

FIGS. 7 and 8 show examples of correlation coefficients in the horizontal (H) and vertical (V) directions obtained by using Formulae 3 and 4, respectively.

As shown in FIG. 7, when one image shifts in a horizontal direction by “zero” relative to the standard image, in other words, when both images completely overlap each other, a correlation between both images is “1.0” (maximum). When one image shifts in a horizontal direction by “one” pixel relative to the standard image, a correlation between both images changes to about “0.9”, also, when one image shifts in a horizontal direction by “two” pixels, a correlation between both images changes to about “0.75”, which shows that the increase in the shift (number of pixels) in a horizontal direction gradually decreases the correlation between both images.

Also, as shown in FIG. 8, when one image shifts in a vertical direction by “zero” relative to the standard image, in other words, when both images completely overlap each other, a correlation between both images is “1.0” (maximum). When one image shifts in a vertical direction by “one” pixel relative to the standard image, a correlation between both images changes to about “0.8”, also, when one image shifts in a vertical direction by “two” pixels, a correlation between both images changes to about “0.65”, which shows that the increase in the shift (number of pixels) in a vertical direction also gradually decreases the correlation between both images.

As a result, when the shift is relatively small, in other words, within a range of a certain number of pixels, the difference between both images in image feature quantities is small and it is conceivable that the image feature quantities in the images are almost the same.

In this embodiment, the range in which the value of the image feature quantity or the changing pattern is considered to be constant (threshold value or less) is up to “four” pixels in a horizontal direction and “3” pixels in a vertical direction as shown by an arrow in FIGS. 7 and 8 although the range changes according to detection speed, detection reliability and so on. With the shift within this range, since the change of the image feature quantity is small, the range may be treated as the range of shift within a certain range. In this embodiment as a result, the image area can be compressed dimensionally up to 1/12 (6×8=48 dimensions/24×24=576 dimensions) without damaging the feature of the originally-selected area.

As described above, the invention has been worked out by focusing on the fact that the image feature quantity has a certain range, in which the range in which the auto-correlation coefficient does not fall below a certain value is treated as one block, and the image feature vector constituted by the representative value in each block is employed.

When the detection target area has been dimensionally compressed in this way, calculating the image feature vector constituted by the representative value in each block and it is detected whether the face image exists or not in the area by inputting the obtained feature vector into the discriminator (SVM) 30 (step S109).

Then the detection result is shown to a user every time the detection ends or together with other detection results collectively, and moving to step S110, the process ends after the detection process is performed on all areas.

In the examples of FIGS. 4-6, each block consists of 12 (3 by 4) pixels the auto-correlation coefficients of which do not fall below a constant value and which abut each other vertically and horizontally. The average (FIG. 5) and variance (FIG. 6) of the image feature quantity (edge strength) of these 12 pixels are calculated as the representative values of each block. The image feature vectors obtained from the representative values are input into the discriminator (SVM) 30 to perform the detection process.

In the invention, since the discrimination is performed after dimensionally compressing to the extent of not damaging the original feature quantities of the face image, without using all the image feature quantities in the detection target area as they are, the number of calculations can be greatly reduced, so that whether the face image exists or not in the selected area can be quickly and accurately detected.

In this embodiment, in addition, although an image feature quantity based on edge strength is adopted, an image feature quantity based singly on luminance or both luminance and edge strength may be used in the case where the image can be dimensionally compressed more effectively by using the luminance of pixels than by using edge strength depending on the type of image.

Also in the invention, although a “human face” which is the most likely candidate is targeted for the detection target image, other objects such as a “human body type”, “animal face and posture”, “vehicle such as a car”, “building”, “plant” and “topographical formation” can be targeted as well as a “human face”.

In addition, FIG. 9 shows a “Sobel operator” which is a difference type edge detection operator applicable to the invention.

An operator (filter) shown in FIG. 9(a) accentuates an edge in a horizontal direction by adjusting each group of three pixel values located in left and right rows among eight pixel values surrounding a target pixel. An operator shown in FIG. 9(b) accentuates edges in a vertical direction by adjusting each group of three pixel values located in an upper line and lower row among eight pixel values surrounding a target pixel. Thereby the edges in the vertical and horizontal directions can be detected.

By obtaining edge strength by calculating a square root after calculating a square sum of the results generated in each operator, and by generating edge strength or edge variance in each pixel, the image feature vector can be accurately detected. In addition, as described above, other difference type edge detection operators such as “Roberts” and “Prewitt” and a template type edge detection operator can be applied in place of the “Sobel operator”.

Discrimination with high speed and high accuracy can be made by using a neural network in place of the SVM as the discriminator 30.

1. A face image detecting method for detecting whether a face image exists in a detection target image comprising:
after selecting a specific area within the detection target image as a detection target area:
calculating an edge strength within the selected detection target area;
dividing the detection target area into a plurality of blocks based on the calculated edge strength;
calculating feature vectors including a representative value in each block; and
thereafter determining whether the face image exists in the detection target area by inputting the feature vectors into a discriminator.

2. The face image detecting method according to claim 1 wherein a size of the block is determined based on an auto-correlation coefficient.

3. The face image detecting method according to claim 1 further comprising:
calculating a luminance within the detection target area; and
calculating the feature vectors including a representative value in each block based on the luminance.

4. The face image detecting method according to claim 1 wherein at least one of a variance and an average of an image feature quantity of pixels configuring each block is used as a representative value in each block.

5. The face image detecting method according to claim 1 wherein the discriminator further comprises a support vector machine having previously learned a plurality of sample face images and sample non-face images.

6. The face image detecting method according to claim 5 wherein a nonlinear kernel function is used as an identification function of the support vector machine.

7. The face image detecting method according to claim 1 wherein the discriminator further comprises a neural network having previously learned a plurality of sample face images and sample non-face images.

8. The face image detecting method according to claim 1 wherein the edge strength within the detection target area is calculated by using a Sobel operator in each pixel.

9. A face image detecting system for detecting whether a face image exists in a detection target image in which it is unclear whether the face image is included comprising:
an image scanning part for scanning a specific area within the detection target image as a detection target area;
a feature vector calculating part for calculating feature vectors including a representative value in each block by dividing the detection target area scanned in the image scanning part into a plurality of blocks; and
a discriminating part for discriminating whether the face image exists in the detection target area based on the feature vectors including a representative value in each block obtained in the feature vector calculating part.

10. The face image detecting system according to claim 9 wherein the feature vector calculating part comprises:
a luminance calculating part for calculating a luminance in each pixel within the detection target area scanned in the image scanning part;
an edge calculating part for calculating edge strength within the detection target area; and
an average/variance calculating part for calculating at least one of:
an average or a variance of a luminance obtained in the luminance calculating part; and
an average of a variance of an edge strength obtained in the edge calculating part.

11. The face image detecting system according to claim 9 wherein the discriminating part comprises a support vector machine having previously learned a plurality of sample face images and sample non-face images.

12. A face image detecting program for detecting whether a face image exists in a detection target image in which it is unclear whether the face image is included, making a computer function as:
an image scanning part for scanning a specific area within the detection target image as a detection target area;
a feature vector calculating part for calculating feature vectors including a representative value in each block by dividing the detection target area scanned in the image scanning part into a plurality of blocks; and
a discriminating part for discriminating whether the face image exists in the detection target area based on the feature vectors including a representative value in each block obtained in the feature vector calculating part.

13. The face image detecting program according to claim 12 wherein the feature vector calculating part comprises:
a luminance calculating part for calculating a luminance in each pixel within the detection target area scanned in the image scanning part;
an edge calculating part for calculating edge strength within the detection target area; and
an average/variance calculating part for calculating at least one of:
an average or a variance of a luminance obtained in the luminance calculating part; and
an average of a variance of an edge strength obtained in the edge calculating part.

14. The face image detecting program according to claim 12 wherein the discriminating part comprises a support vector machine having previously learned a plurality of sample face images and sample non-face images.

15. A face image detecting method for detecting whether a face image exists in a detection target image comprising:
after selecting a specific area within the detection target image as a detection target area:
calculating a luminance within the selected detection target area;
dividing the detection target area into a plurality of blocks based on the calculated luminance;
calculating feature vectors including a representative value in each block; and
thereafter determining whether the face image exists in the detection target area by inputting the feature vectors into a discriminator.
